(19) United States
(12) Patent Application Publication
(10) Pub. No.: US 2021/0088458 A1
(43) Pub. Date: Mar. 25, 2021

(54) AUTOMATIC MULTIPLE SAMPLE PREPARATION SYSTEM OF FUSED BEADS FOR XRF ANALYSIS

(71) Applicant: Jose Maria Las Navas Garcia, Conway, SC (US)

(72) Inventor: Jose Maria Las Navas Garcia, Conway, SC (US)

(73) Assignee: Jose Maria Las Navas Garcia, Conway, SC (US)

(21) Appl. No.: 17/013,731

(22) Filed: Sep. 7, 2020

(51) Int. Cl. G01N 23/207

(52) U.S. Cl. CPC G01N 23/2076; G01N 2035/0439

(57) ABSTRACT

An automatic multiple sample preparation system of fused beads for XRF analysis from powder samples with a thermogravimetric analyzer type of instrument with automatic sample dosing, automatic flux dosing, fusion furnace, a movable platform, to hold the dosed sample platinum crucibles an external balance for dosing, a gantry type device to transport sample dosing device and vacuum pick up device to move fused beads from beads carousel to tray on XRF instrument for analysis. To transmit from thermogravimetric fusion system, relevant fusion data to the XRF instrument

### CROSS-REFERENCE TO RELATED APPLICATIONS

The contents of U.S. patent application Ser. No. 17/013,731 filed Sep. 7, 2020 on which the present application is based and priority claimed, is herein incorporated by preference

### BACKGROUND OF THE INVENTION

### 1. Field of the Invention

The present invention relates to an automatic multiple sample preparation system of fused beads for XRF analysis or other possible analysis. More particularly, the present invention relates to an automatic system including: sample dosing, flux dosing, dosing head cleaning fusion of samples and flux in a furnace and taking weights during the fusion, cooling beads after fusion, moving beads to XRF instrument for analysis, alternatively placing beads in a tray.

### 2. Description of Related Art

It is well known that the processing of powder samples mixed and dosed with flux, then fused in a furnace and cooled and the beads resulted from this operation transported to an XRF spectrometer for chemical analysis is a complex process.

### SUMMARY OF THE INVENTION

It is therefore the general object of the present invention to provide an automatic system based on a gantry type displacement system with vertical and horizontal displacement of dossing head and vacuum sucker together with a moving large rotating carousel with 3 movements, rotation, linear displacement and elevation and an external balance to do the dosing of samples and flux, clean sample dosing head, fuse the mixtures sample and flux in a furnace, cool the fused beads, transport automatically cooled beads and data direct to an XRF analyzer for chemical analysis, conveyor or any other instrument available, alternatively transport the beads manually in a multiple sample tray to a remote analyzer.

Other objectives, features and advantages of the present invention will become apparent from the following detailed description of the invention taken in conjunction with the accompanying drawings.

### BRIEF DESCRIPTION OF THE DRAWINGS

Having described the invention in general terms, reference will now be made to the accompanying drawings, which are not necessarily drawn to scale, in which like numerals refer to like parts and in which:

FIG. 1 Is an overall perspective view of the automatic multiple sample preparation system of fused beads for XRF analysis;

FIG. 2 illustrates a portion of the dosing system of the present invention picking up a sample from the multiple sample carousel;

FIG. 3 shows that portion of the dosing system of the present invention illustrating the dosing samples having been transferred to the destination carousel crucible;

FIG. 4 illustrates the dosing device cleaning mechanism of the present invention showing the dosing device head in vacuum cleaning position;

FIG. 5 is a perspective view illustrating the horizontal gantry assembly and dosing device elevation of the present invention;

FIG. 5 is a perspective view illustrating the destination carousel crucible being dosed by the flux;

FIG. 6 is a view illustrating the sample-flux destination carousel assembly with crucibles positioned for crucible introduction to furnace for fusion;

FIG. 7 is a view illustrating the sample-flux destination carousel assembly with crucibles positioned for crucible introduction to furnace for fusion raised by furnace ejector;

FIG. 8 is a view illustrating the sample-flux destination carousel assembly with crucibles positioned for crucible introduction to furnace for fusion raised by furnace ejector, carousel backwards;

FIG. 9 is a view illustrating the sample-flux destination carousel assembly with crucibles positioned for crucibles inside the furnace (ejector down) for fusion;

FIG. 10 is a view illustrating the sample-flux destination carousel assembly with crucibles positioned for crucibles after fusion for cooling;

FIG. 11 is a view illustrating the carousel assembly with crucibles positioned for crucibles after cooling for beads picked up by suction cup in lower position;

FIG. 12 is a view illustrating the carousel assembly with crucibles positioned for crucibles after cooling for beads picked up by suction cup in upper position, bead released from crucible;

FIG. 13 is a view illustrating the suction cup transporting the bead to the XRF instrument entrance;

FIG. 14 is a view illustrating the suction cup transporting the bead to the XRF instrument entrance, bead deposited inside XRF instrument ready for analysis;

FIG. 15 is a view illustrating the alternative method of moving the fused beads to a tray with multiple positions for later manual carrying to a remote X1211 instrument;

FIG. 16 is a view illustrating the alternative method of moving the fused beads to a tray with multiple positions for later manual carrying to a remote XRF instrument, bead up;

FIG. 17 is a view illustrating the alternative method of moving the fused beads to a tray with multiple positions for later manual carrying to a remote XRF instrument, bead up deposited; and

FIG. 18 is a view illustrating the alternative method of moving the fused beads to a tray with multiple positions for later manual carrying to a remote XRF instrument, tray removed.

### DESCRIPTION OF THE PREFERRED EMBODIMENT(S)

The present inventions now will be described more fully hereinafter with reference to the accompanying drawings, in which preferred embodiments of the invention are shown. This invention may, however, be embodied in many different forms and should not be construed as limited to the embodiments set forth herein; rather these embodiments are provided so that this disclosure will be through and complete and will fully convey the scope of the invention to those skilled in the art. Like numbers refer to the elements throughout.

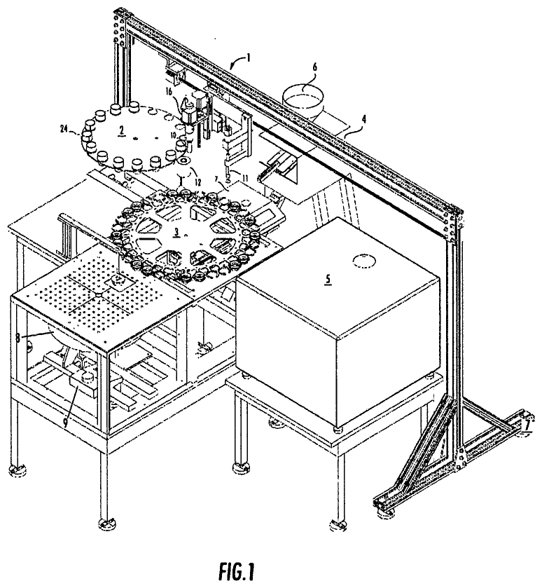

There is shown in FIG. 1 the automatic multiple sample preparation system of fused beads for XRF analysis of the present invention that includes, a gantry type frame 1, a samples carousel with crucibles 2, a beads carousel with platinum crucibles 3, flux dosser 4, XRF spectrometer 5, flux container 6, external balance 7, fusion furnace 8, furnace balance 9, sample dosser device 10, vacuum pick up device 11, vacuum cleaning tube 12, furnace plug 13.

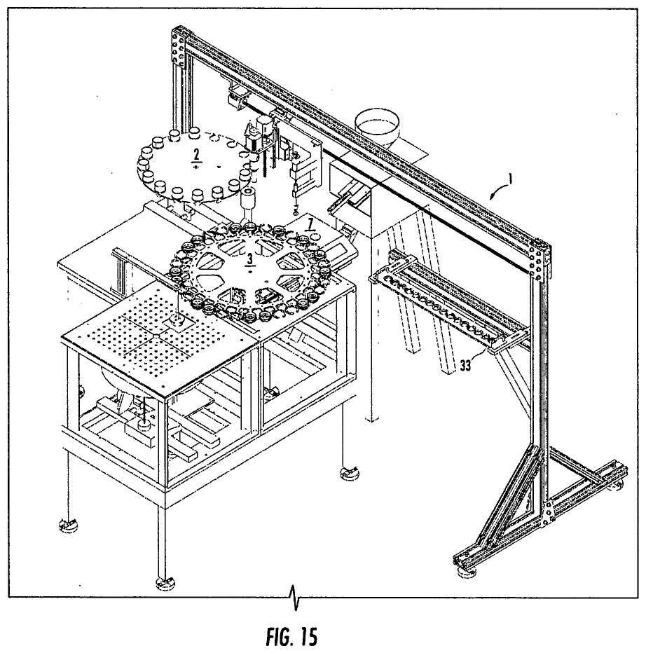

A samples carousel 2 on one portion, an external rotating carousel for receiving samples in sample crucibles or cups. Multiple different samples are arranged in the receiving carousel 2 for automatic sequential filling and later to be dosed and weighed in beads carousel 3 is rotated around its axis by a motor (not shown) synchronized with the sample dosing device 10. On another portion is bead carousel 3 containing a flux/secondary dosing sample. There is also provided module 4 which is used to provide a second type of dosing or a flux and is positioned in proximity to the destination carousel 3. The carousels are serviced by a gantry assembly including support frame 1 which provides support for transferring elements from one carousel to the other. There is also provided a dosage device cleaning mechanism 12. A vacuum device 11 is also attached to the gantry slide to move fused beads 14 from crucibles in beads carousel 3 to XRF spectrometer 5, or as shown in the alternative embodiment of FIGS. 15-17 beads tray 15.

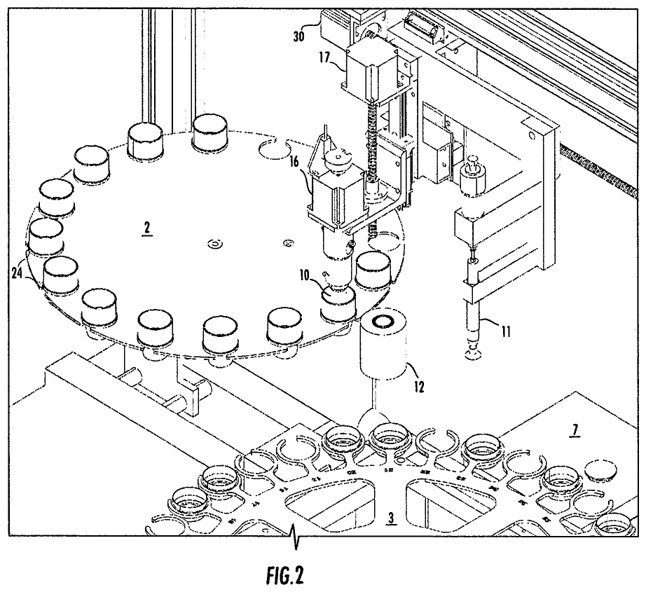

Samples are provided in cups of enough capacity for the sample dosing device 10 to fill the need volume of sample later used for sample dosing. As shown in FIG. 2, a portion of the dosing system has sample carousel 2. Dosing device 10, supported by gantry 1, removes a sample from the samples carousel 2 and transfers the sample to beads carousel 3. The sample carousel 2 may contain bar code tags.

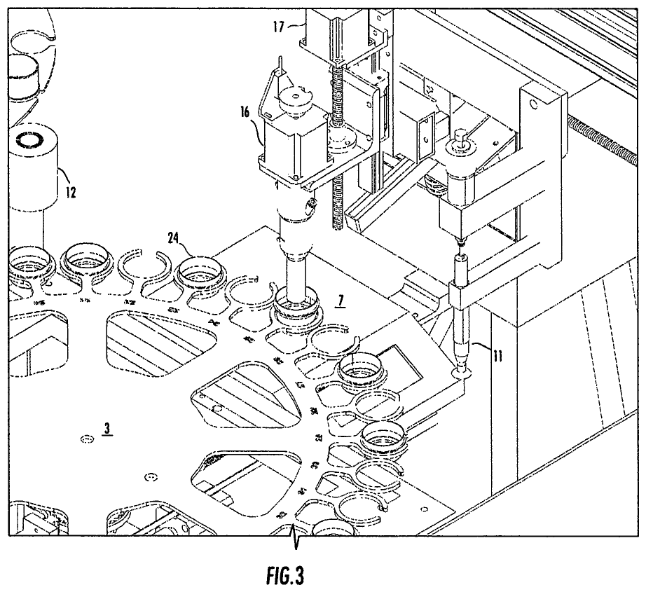

FIG. 3 shows that portion of the dosing system illustrating a plurality dosing samples having been transferred to the sample vessels, positioned in beads carousel 3 and deposited on the balance pedestal where the samples are weighed on precision balance 7 connected to rotating beads carousel 3 with samples vessels with vertical pneumatic positioning for vessels to be deposited on balance 7. There is also shown dosing device 10 controlled by motor 16 which doses samples by partially opening and closing an aperture at high speed. Also shown is vacuum cleaning module 12 and vacuum cleaner (not shown).

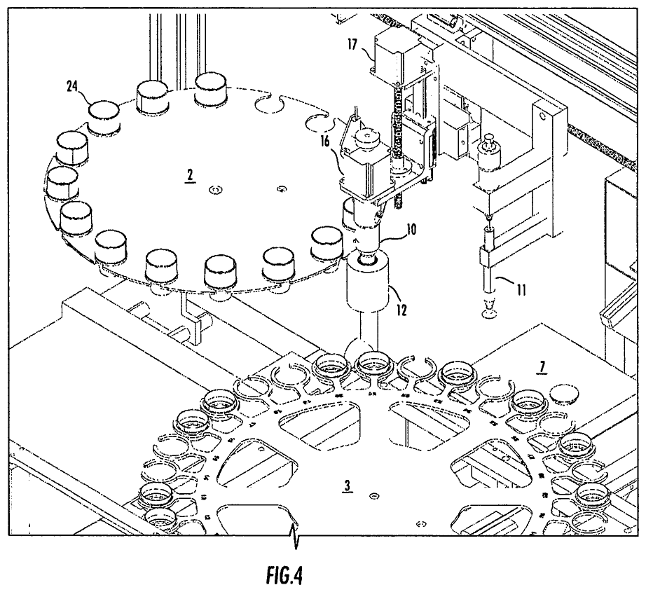

It is essential in order to obtain accurate results that the dosing device 10 be clean before its next use. The present invention uses a cleaning station, shown in FIG. 4 as cleaning mechanism tube 12, to clean the dosing device 10 after each sample is dosed and before a new sample is collected. In FIG. 4 there is shown the cleaning mechanism 12 positioned between carousels 2, 3. The cleaning mechanism 12 comprises vacuum pump (not shown) located in the vacuum box which supports the cleaning when the dosing device 10 is opened and closed repeatedly turning vacuum on and off automatically. The dosing device 10, as shown in FIG. 4, is in the vacuum cleaner (not shown), ready for vacuum and compressed air cleaning. A circular brush (not shown) surrounds the dosing device head 10 as it enters the vacuum cleaner and is integrated with the cleaning vacuum system to clean the external part of the dosing device head 10 as it moves inside the cleaning system.

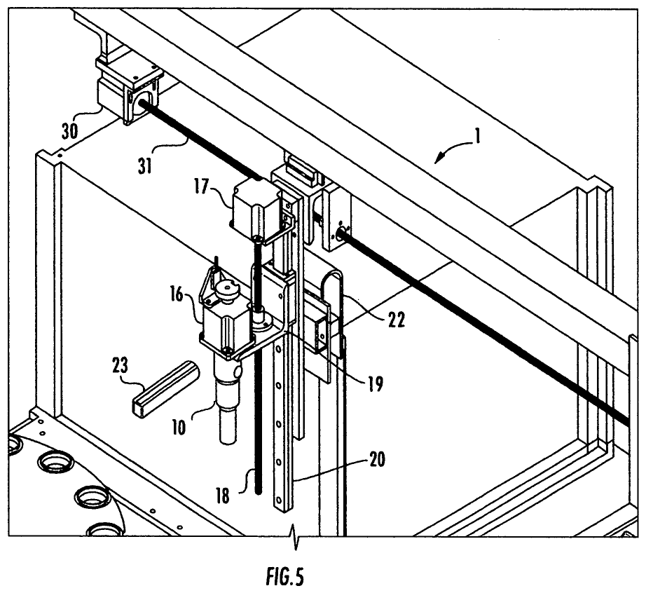

Moving the dosing device from station to station is provided by the gantry shown in FIG. 5. The gantry frame 1 supports the various elements. Vertical movement of the dosing device 10 is controlled by the vertical displacement assembly with motor 17 causing the dosing device to move vertically along screw 18. The vertical assembly is supported by angle 19 and moved along support 20 by vertical slider 21. The dosing device 10 is moved linearly along screw 31 which is controlled by linear displacement assembly with motor 30. There is an external vibrating mechanism 22 to vibrate before collecting sample with dosing device window open vibrating after collecting sample with window in dosing device closed to remove part of the excess sample and to support dosing operation later at dosing operation.

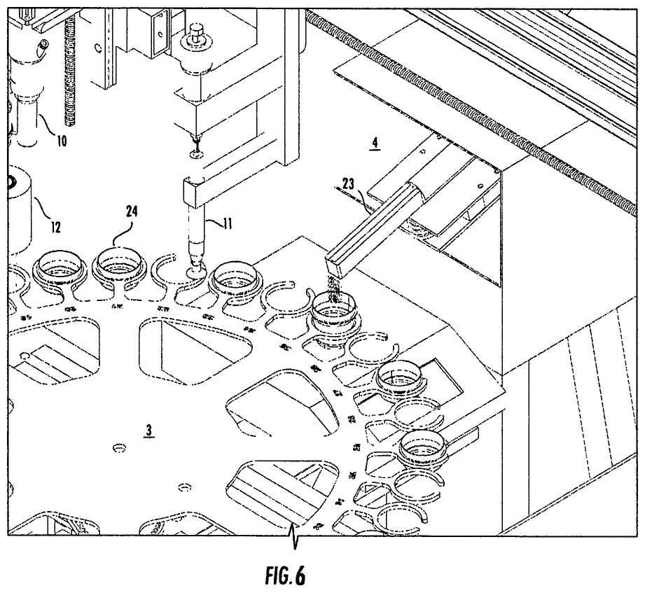

The invention also provides a second dosing module or station 4, shown in FIG. 6, to dose flux or a secondary sample by balance gravimeter into the same crucible or destination vessel. The second dosing module 4 doses sequentially by vibration or other means to add flux or a secondary dosing to sample cups in the gravimetric moving station when the moving station is positioned in flux dosing position. As shown, the secondary dosing or flux is added through tube 23. This arrangement allows multiple vessels to be dosed at specific amounts before or after the samples are further dosed/fluxed. This operation is repeated until all sample cups have dosed sample and flux and information of weights of vessel, dosed sample and flux is analyzed.

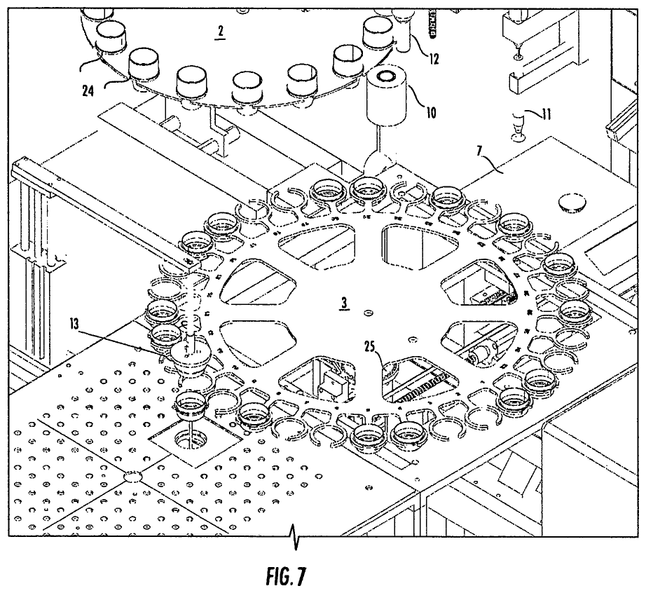

FIG. 7 illustrates the destination carousel assembly, balance weighing and piston assembly of the present invention. The dosed sample platinum crucibles 24 are positioned in openings in bead carousel 3 which is rotable The beads carousel 3 has vertical movement and horizontal movement provided by screw and motor 25. The vertical and horizontal movement enables the beads carousel to move to and from the second/flux dosing module 4. The dosed samples in the beads carousel 3 are automatically deposited on the balance pedestal 26 for weighing by precision balance 7. After sample dosing, horizontal motor 25, shown in FIGS. 5 and 7, to the flux dosing position to automatically dose flux to crucibles 24 through tube 23 and by module 4 with balance 7 in the down position.

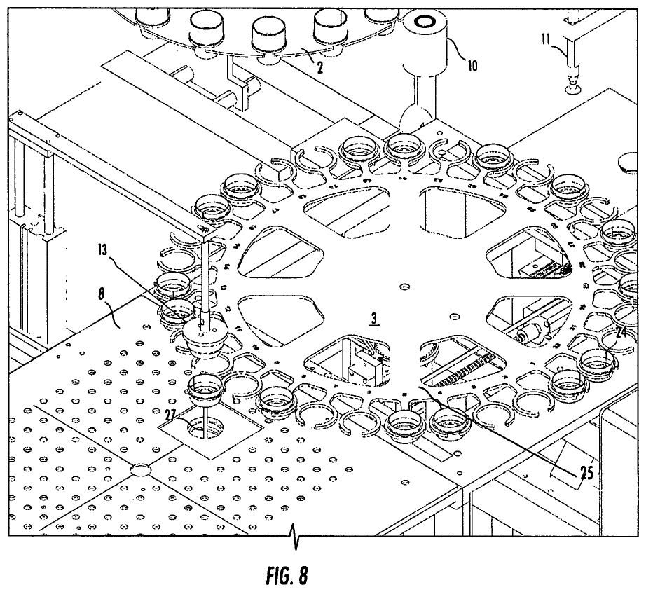

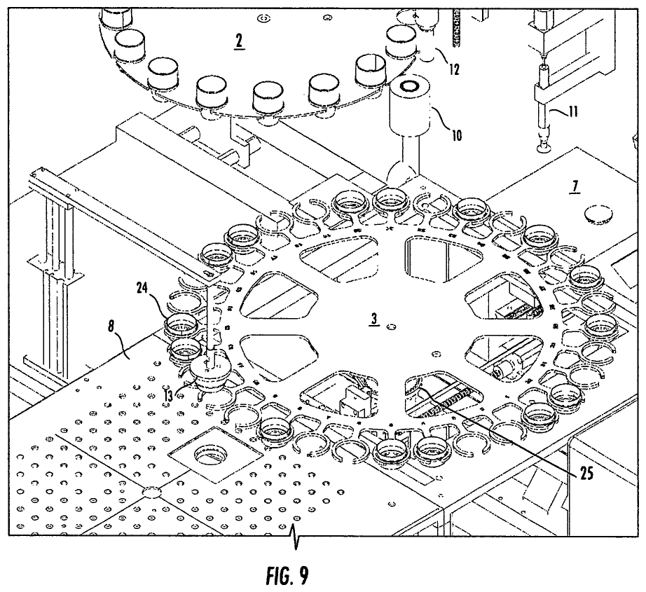

One the crucibles 24 have been properly fluxed they are heated in furnace 8 as shown in FIGS. 8-9. FIG. 8 is a view illustrating the sample-flux destination bead carousel assembly 3 with crucibles 24 positioned for crucible introduction to furnace 8 for fusion. The furnace ejector 27 raises the crucible from the bead carousel assembly 3 and the motor and screw 25 retracts and lowers the crucible 24 into the furnace 8. FIG. 9 illustrates the sample-flux destination bead carousel assembly 3 with crucibles positioned inside the furnace 8 (the ejector 27 is in the down position) for fusion. The furnace is closed during fusion by furnace plug 13.

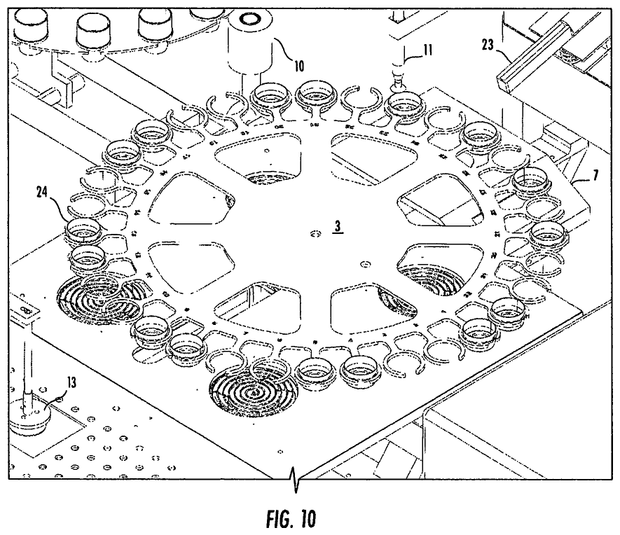

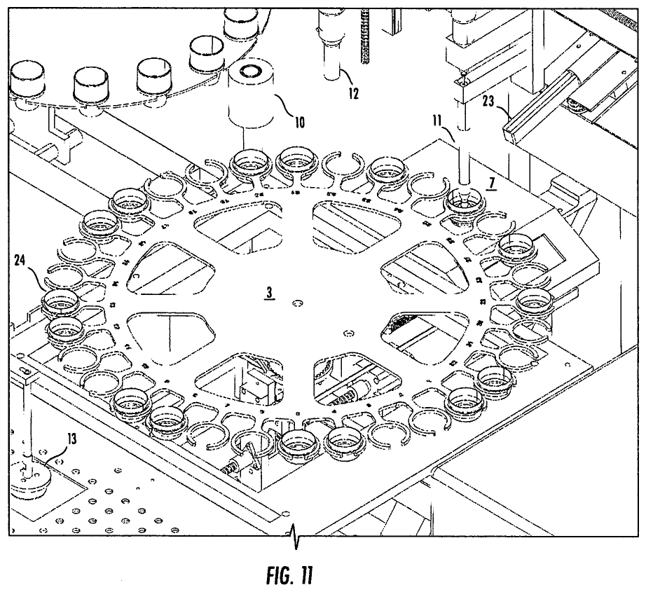

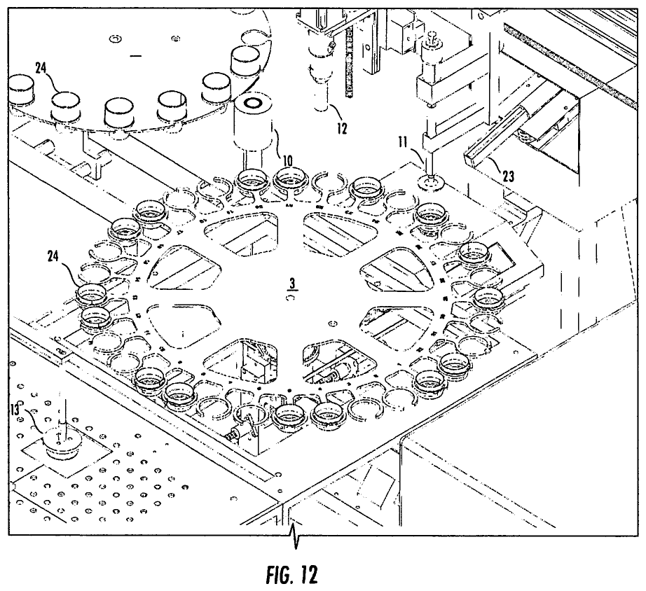

FIG. 10 is a view illustrating the sample-flux destination bead carousel 3 with crucibles 24 positioned for crucible pickup after fusion and ready for cooling. FIG. 11 is a view similar to FIG. 10 illustrating the bead carousel 3 with crucibles 24 positioned for pickup of cooled beads by suction cup 11 shown in lower position. FIG. 12 is a view illustrating the bead carousel 3 with crucibles 24 positioned after cooling for beads to be picked up by suction cup 11 in upper position. The bead is released from crucible.

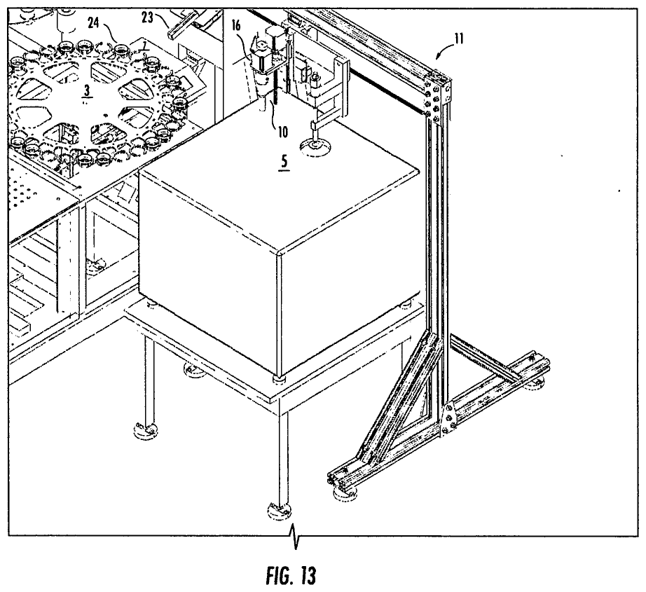

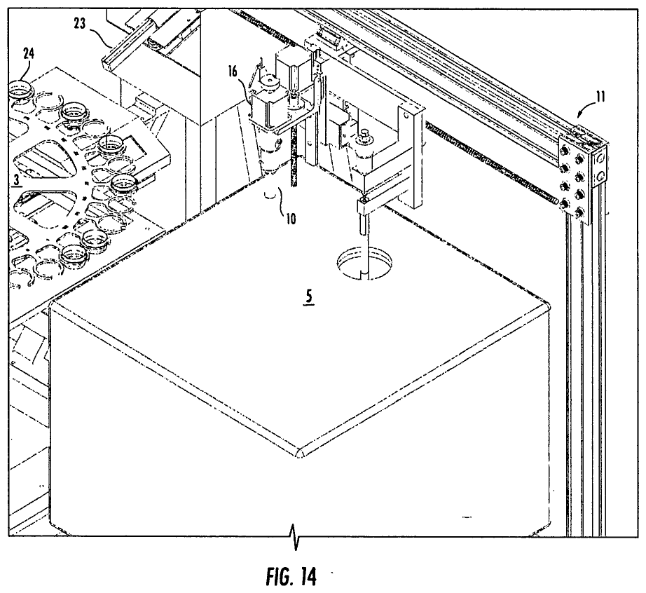

FIG. 13 is a view illustrating the suction cup 11 transporting the bead to the XRF instrument 5 entrance. FIG. 14 is a view illustrating the suction cup 11 transporting the bead to the XRF instrument 5 entrance, bead deposited inside XRF instrument ready for analysis.

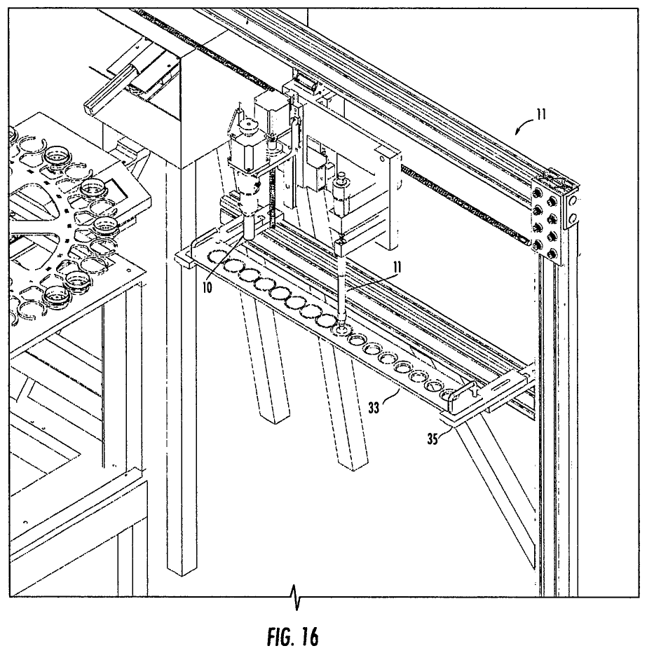

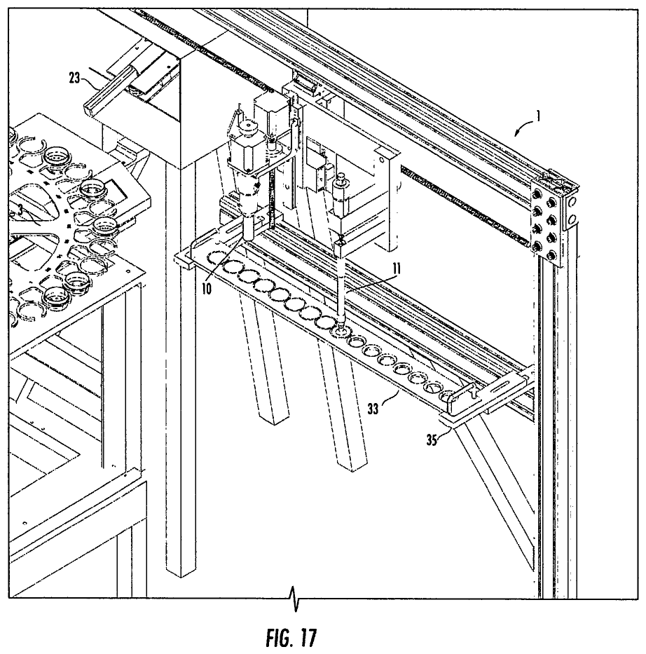

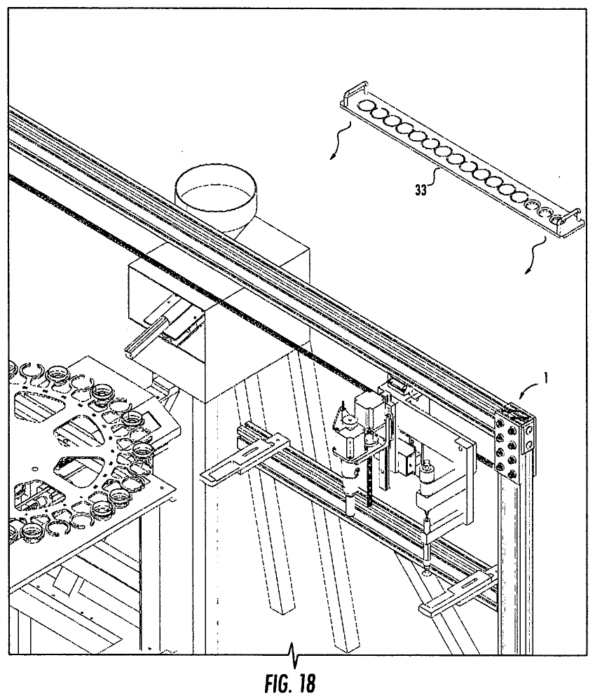

FIG. 15 is a view illustrating the alternative method of moving the fused beads to a tray 33 with multiple positions for later manual carrying to a remote XRF instrument; FIG. 16 illustrates a detailed view of the tray 33 show the tray support 35. FIG. 17 is another view illustrating the alternative method of moving the fused beads to a tray 33 with multiple positions for later manual carrying to a remote XRF instrument, bead up deposited. FIG. 18 is a view illustrating the alternative method of moving the fused beads to a tray 33 with multiple positions for later manual carrying to a remote XRF instrument showing the tray removed from the tray support 35.

Many modifications and other embodiments of the inventions set forth herein will come to mind to one skilled in the art to which these inventions pertain having the benefit of the teachings presented in the foregoing descriptions. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

I claim:

1. An automatic multiple sample preparation system of fused beads for XRF or other possible Analysis, comprising;
a gantry assembly for controlling the horizontal and vertical movements of a dosing device;
a first carousel for sequentially receiving multiple samples to be dosed in sample cups, means for rotating said first carousel and synchronizing said rotation with said dosing device;
a first balance scale for weighing samples to be dosed;
said dosing device having a dosing head and being capable of moving said samples from said first carousel, dosing said samples though said dosing head through which the dosing material is moved into said sample cup and moving said samples to a destination carousel;
a cleaning mechanism for cleaning said dosing head following each dosing, said cleaning mechanism being positioned between said first carousel and said destination carousel;
said destination carousel having openings for receiving said dosed sample cups, said destination carousel having means for rotation movement and vertical and horizontal movement; and a second balance scale for weighing said dosed sample cups

2. The gravimetric dosing and cleaning system according to claim 1 wherein said gantry assembly comprises:
a support frame for controlling the vertical and horizontal movement of said dosing device;
a vertical displacement assembly that includes motor suitably connected to said support frame for moving said dosing device vertically by vertical slider along a screw; and
a linear displacement assembly the includes a motor supported by a slider along a screw.

3. The gravimetric dosing and cleaning system according to claim 1 wherein said cleaning mechanism for cleaning said dosing device comprises:
a vacuum pump located in a vacuum box which supports said cleaning mechanism;
a cleaner connected to said vacuum pump for receiving said dosing device head;
a circular brush within said vacuum cleaner and surrounding said dosing device head as it enters said vacuum cleaner,

4. The gravimetric dosing and cleaning system according to claim 1 further comprising a secondary dosing or flux device for dosing said samples.

5. The gravimetric dosing and cleaning system according to claim 1 further comprising a vibrating mechanism positioned to vibrate said sample to facilitate said dosing device entrance to said sample and to release particles on the device surface to the sample cup.

6. The gravimetric dosing and cleaning system according to claim 1 wherein said dosing device comprises:
a motor for rotating said dosing head is supported to vertical assembly;
a dosing head housing connected to said motor; and
a dosing head extending from said dosing head housing.

7. The gravimetric dosing and cleaning system according to claim 1 wherein linear and vertical movement of said destination carousal is provided by pneumatic cylinders.

8. A multiple sample gravimetric dosing and cleaning system for analyzing a dosed sample of material comprising:
a gantry assembly for controlling the horizontal and vertical movements of a dosing device; said gantry assembly comprising a support frame for controlling the vertical and horizontal movement of said dosing device; a vertical displacement assembly that includes a motor suitably connected to said support frame for moving said dosing device vertically by vertical slider along screw; and a linear displacement assembly the includes a motor supported by a slider along a screw.
a first carousel for sequentially receiving multiple samples to be dosed in sample cups, means for rotating said first carousel and synchronizing said rotation with said dosing device;
a first balance scale for weighing samples to be dosed;
said dosing device having a dosing head and being capable of moving said samples from said first carousel, dosing said samples though said dosing head through which the dosing material is moved into said sample cup and moving said samples to a destination carousel;
a secondary dosing device for dosing or fluxing said sample.
cleaning mechanism for cleaning said dosing head following each dosing, said cleaning mechanism positioned between said first carousel and said destination carousel and comprising a vacuum pump located in a vacuum box which supports said cleaning mechanism, a cleaner connected to said vacuum pump for receiving said dosing device head, and a circular brush within said cleaner and surrounding said dosing device head as it enters said vacuum cleaner;
said destination carousel having openings for receiving said dosed sample cups, said destination carousel having means for rotation movement and vertical and horizontal movement; and
a second balance scale for weighing said dosed sample cups.

9. The system of claim 1 further comprising a vibrating mechanism positioned to vibrate said sample to facilitate said dosing device entrance to said sample and to release particles on the device surface to the sample cup.

10. The gravimetric dosing and cleaning system according to claim 1 wherein said dosing device comprises: a motor for rotating said dosing head is supported to vertical assembly;
a dosing head housing connected to said motor; and a dosing head extending from said dosing head housing.

11. A method of preparing a sample for X-ray spectrometry analysis in a thermogravimetric analyzer of the type including a furnace, a movable platform within said furnace, a tilt member having a plurality of each stations, each station having a center point of said station in a different direction, said method comprising the steps of:
a. providing a sample holder suitable for use in X-ray spectrometric analysis containing the material to be analyzed and the flux;
b. placing the sample holder onto the platform within the furnace to heat the sample and flux;
c. mixing the material to be analyzed and the flux in the sample holder within said furnace to form a substantially homogenous mixture by moving the platform relative to the tilt member such that the sample holder aligns with said suggestive stations of said tilt member, and the pin of each aligned station abuts and tilts the sample holder in a direction determined by the location of said pin of said aligned station;
d. removing the sample holder from the furnace; and
e. allowing the contents of the sample holder to cool and form an X-ray fused bead

12. The method of claim 11 wherein the step of mixing the material to be analyzed and the flux comprises the step of repeatedly causing the sample holder to tilt in different directions as the platform is moved

13. The method of claim 11 wherein the platform is rotable and linearly movable relative to the tilt member to repeatedly tilt the sample holder in different directions

14. The method of claim 11 further comprising the step of agitating the contents of the sample holder by rapidly moving the platform back and forth with sudden stops.

15. The method of claim 11 wherein the thermogravimetric analyzer is associated with an external balance and an internal balance, further comprising of the steps of:
f. weighing the sample holder with the material to be analyzed and the flux on the external scale prior to placing it into the furnace:
g. weighing the sample holder with the material to be analyzed and flux within the furnace, after it is heated;
h. comparing the weight of the sample holder prior to placing it into the furnace with the weight of the sample holder prior to placing it in the furnace with the weight of the sample holder after it is heated in the furnace to determine the loss on ignition/gain on ignition value of the material to be analyzed; and
i. using the loss on ignition/gain on ignition value in the X-ray spectrometry analysis.

16. The method of claim 11 wherein the step of using the loss on ignition/gain on ignition value comprises the steps of:
j. Providing the value to the X-ray spectrometry analysis equipment; and
k. Using the value to adjust the results of the X-ray spectrometry analysis

17. A gantry assembly for controlling the horizontal and vertical movements of a vacuum pick up device;
Said vacuum device capable of moving said beads from said samples holder by vertical and horizontal movement to the X-ray spectrometer sample entrance for analysis or optionally to a X-ray spectrometer conveyor or a samples tray for further moving the beads manually to the an external X-ray spectrometer for analytical evaluation
